(19) United States
(12) Patent Application Publication
(10) Pub. No.: US 2004/0112184 A1
(43) Pub. Date: Jun. 17, 2004

(54) Gearcase service tool

(76) Inventor: Brian Stafford, Little Egg Harbor, NJ (US)

Correspondence Address: John B. Dickman, III, Suite 1203, 2001 Jefferson Davis Highway, Arlington, VA, 22202, US

(21) Appl. No.: 10/320,396

(22) Filed: Dec. 17, 2002

(51) Int. Cl. B25B 23/00

(52) U.S. Cl. 81/439

(57) ABSTRACT

A drain plug removal tool having a handle and a tool shaft, where the tool shaft has tool tips on each end, each tip having straight edges and a bottom edge for engaging the bottom of a square screw slot, one tip being larger that the other; the handle having a slot for receiving the tool shaft where the handle has a bore which aligns with the slot so that a pin connects the handle to the tool shaft.

### BACKGROUND OF THE INVENTION

The present invention relates to a marine gearcase oil drain plug removal tool and, in particular, a drain plug removal tool having multiple working ends and a disassemble handle for changing working ends.

Removing oil drain screws or drain plugs from marine gearboxes has been done with a screwdriver and a wrench or an impact type screwdriver and hammer. The problem with using a screwdriver is the tip is tapered, and therefore, it will more than likely cause a square screw slot in the drain plug to strip. This problem of stripping a square screw slot is even more pronounced where the width of a square screw slot is wider than the thickness of the tapered screwdriver.

When an impact type screwdriver and hammer are used to remove drain plugs, violent impacts are produced from the heavy pounding and turning, resulting in stripped screw slots. The resulting damage to a drain plug would often render the square screw slots useless, requiring drilling and or tapping to remove the drain plug.

Generally two tools-a screwdriver and a hammer, or an impact type screw driver and hammer are needed to remove and install drain plugs. The present invention overcomes the several problems of the known drain plug removal tools. The one tool of the invention has multiple square driver tips having varying tip widths for different engine and gearcase manufacturer's drain plugs. The elimination of two tools is accomplished by a “T” handle, which connects to a shaft having different tip widths on its ends.

The principle object of the invention is to provide a non-slip method for installing and removing oil drain plug screws in marine gearcases.

Another object of the invention is to provide a single tool to perform the removal and installation of a drain plug screw without the usual stripping and damage to the screw slot.

A further object of the invention is to provide a drain removal tool which is convertible from one square tip to another of different widths.

### SUMMARY OF THE INVENTION

The drain plug removal tool of the invention has a tool shaft with drain plug removal tips on each end. Each tip is specifically designed to fit in the square screw slot of one or more of the gearcase manufacturer's drain plugs. A tool T-handle with a securing pin for connecting the tool shaft to the T-handle is shown.

The removal tips each have a straight tip as opposed to the tapered screwdriver currently used. Where the square edge of the straight tip engages the bottom of the square screw slot of the drain plug there are radius grooves to have proper bottom engagement, and a positive lock against slipping. This is particularly important on certain gearcase manufacturer's drain plug screws.

Each tool has a protective finish against corrosion from harsh marine environments. The tool shaft is stamped to identify to tool tip with the proper gearcase manufacturer.

### DESCRIPTION OF THE DRAWINGS

FIG. 1 is an isometric view of a drain plug removal tool of the invention;

FIG. 2 is a cross-section view taken along the line A—A of FIG. 1;

FIG. 3 is a cross-section view taken along the line B—B of FIG. 1; and,

FIG. 4 is a front elevation of a driver tip of the invention.

### DESCRIPTION OF THE INVENTION

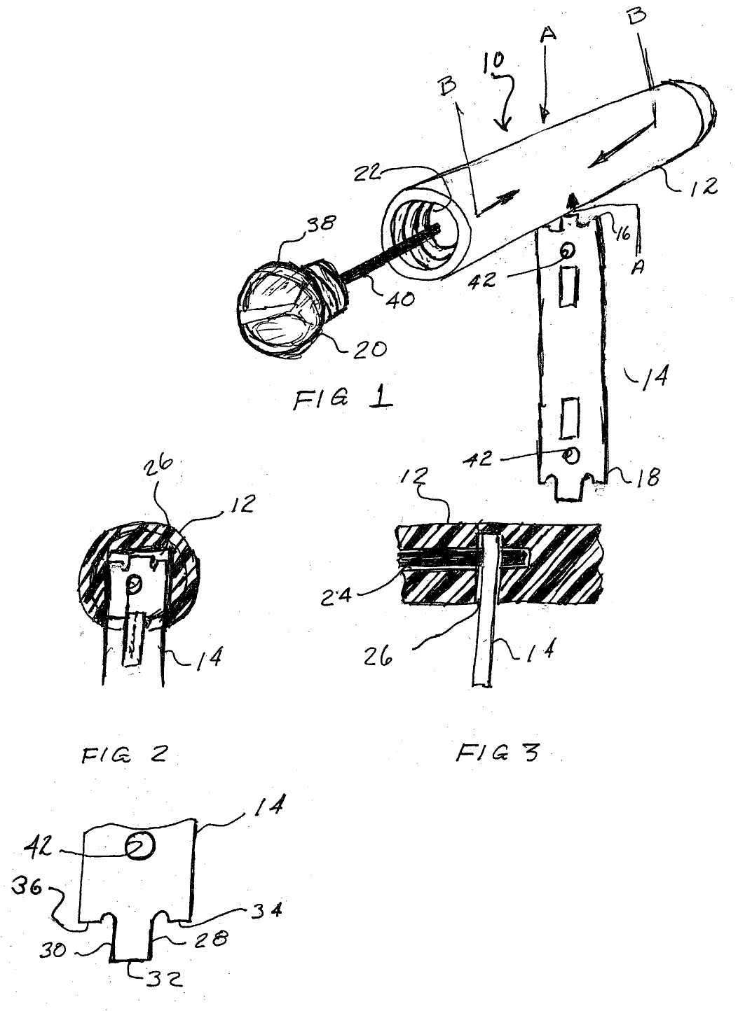

Referring to the drawings, FIGS. 1-4, there is shown a gearcase drain plug removal tool 10 of the invention. Drain plug removal tool 10 has three interconnected parts: a handle 12, a tool shaft 14 having tool ends 16 and 18, and a connecting pin 20 which connects the handle 12 to tool shaft 14, forming a T-shaped handle and tool.

Tool handle 12, shown in FIG. 1 has a cylindrical shape with a threaded bore 22 leading to a center bore 24, FIG. 3, extending beyond a transverse slot 26, FIGS. 2 and 3. The tool handle 12 is made of aluminum material of high tensile strength. Bores 22 and 26 are milled in the aluminum. Other materials like different metals, steel, brass, plastic etc. and some hard woods can be used in making a tool handle.

Tool shaft 14 is made of a temper hardened steel in a flat rectangular shape with tool ends 16 and 18. Each tool end is different from the other so that more than one manufacturers gearcase drain plug can be removed by selecting the correct end. To identify which end fits the drain plug of a manufacturer, the end has and identifying manufacturer's mark.

FIG. 4 shows what a typical tool end will look like; tool end 16 is shown. Tool tip 16 has straight edges 28 and 30 and a square screw slot engaging bottom edge 32. A second of bottoming edges 34 and 36 engage the surface of the gearcase screw not shown, to ensure that the tool end 14 is properly aligned before the drain plug is turned in order to prevent damage to the square screw slot, not shown. The tool tip 14 is now locking in the slot for non-slip removal by turning the T-handle 12. Tool end 18 is similar to tool end 16 except the length of bottom edge 32 is curved.

A protective coating is provided to protect from the corrosive conditions in marine environments.

Connecting pin 20 has a threaded knob 38 and shaft 40, which is screwed into threaded, bore 22 of T-tool handle 12. When the knob 38 is completely screwed in T-tool handle 12 and tool shaft 14 has been inserted in T-tool handle slot 26 to where a hole 42 in the tool shaft 14 aligns with T-tool handle center bore 24, the connecting pin 20 secures tool shaft 14 to the T-tool handle. If tool tip 18 is or has been used and it is necessary to use tool tip 16, threaded knob 38 is unscrewed from T-tool handle 12, thereby releasing the tool shaft 14. Rotating the tool shaft 14 180 degrees and replacing the tool shaft 14 in T-tool handle slot 26 and screwing threaded knob 38 into the T-tool handle 12 will lock tool shaft 14 in place.

While the invention has been explained in one embodiment, other embodiments may be realized from studying the description and drawings, however, one should consider the total invention in view of the claims.

1. A tool for removing drain plugs from marine gearcases, comprising:
a tool shaft having a first end and a second end;
a first tool tip on said first end;
a second tool tip on said second end, where said second tool tip is different from said first tool tip; and,
a handle for attaching to said tool shaft to rotate one of said first or second tool tips to remove or install a drain plug.

2. A tool tip as in claim 1 wherein said first tool tip and said second tool tip each extend from said tool shaft, where said tool shaft has straight side walls which end in said first and second tip, each having a pair of lands, each having a radius ending in straight tool edges parallel to said side walls of said tool shaft, said straight tool edges end in a perpendicular bottom edge, and where the distance between said straight tool edges is less than the width of said tool shaft side walls.

3. A tool as in claim 2 wherein said first tool tip has a wider tool tip than said second tool tip.

4. A tool tip as in claim 3 wherein said tool shaft has a pair of apertures, one above said lands of said first tool tip and the other above said second tool tip.

5. A tool as in claim 4 wherein said handle has an elongated shape with a first bore in one, where said bore has screw threads, a second bore of smaller diameter that said first bore where said second bore extends more than halfway through said elongated shape; a slot transverse to said second bore at about the middle of said elongated shape, where said slot being of a size to allow said tool shaft to slide into and align with one of said apertures in said tool shaft with said second bore; and a means having a connecting pin for passing through said second bore and said aperture in said tool to secure said tool shaft to said handle.
